(19) United States
(12) Patent Application Publication
(10) Pub. No.: US 2008/0167083 A1
(43) Pub. Date: Jul. 10, 2008

(54) Method, Device, and Graphical User Interface for Location-Based Dialing

(76) Inventors: Jeremy A. Wyld, San Jose, CA (US); Jeffrey Bush, San Jose, CA (US)

Correspondence Address: MORGAN LEWIS & BOCKIUS LLP/ APPLE INC., 2 PALO ALTO SQUARE, 3000 EL CAMINO REAL, PALO ALTO, CA, 94306, US

(21) Appl. No.: 11/769,692

(22) Filed: Jun. 27, 2007

Related U.S. Application Data
(60) Provisional application No. 60/883,800, filed on Jan. 7, 2007.

(51) Int. Cl. H04B 1/38

(52) U.S. Cl. 455/566

(57) ABSTRACT

A portable communications device receives from a user a first sequence of symbols that includes a phone number that corresponds to a destination number for a call. If the first sequence of symbols includes a predefined universal international access code symbol followed by the phone number, the device sends an address message corresponding to the first sequence of symbols to a communications network; and if the first sequence of symbols does not include the predefined universal international access code symbol followed by the phone number, the device determines a second sequence of symbols that correspond to the destination number, including the predefined universal international access code symbol if the portable communications device is presently located in a country other than the home country of the portable communications device, and sends an address message corresponding to the second sequence of symbols to the communications network.

### RELATED APPLICATIONS

This application claims priority to U.S. Provisional Patent Application No. 60/883,800, filed Jan. 7, 2007, entitled “Method, Device, and Graphical User Interface for Location-Based Dialing,” which application is incorporated by referenced herein in its entirety.

### TECHNICAL FIELD

The disclosed embodiments relate generally to portable communications devices, and more particularly, to a method, device, and graphical user interface for location-based dialing.

### BACKGROUND

Dialing a phone number on a portable communications device (e.g., a cell phone) is a relatively straightforward process if the user is located in his/her home country and is dialing a destination number in his/her home country. The process is more complex, however, if the user is located outside his/her home country and/or is trying to dial a destination number outside his/her home country. In these situations, the complexity arises because the user needs to dial the appropriate international access code for the country in which the user is presently located and the country code for the country being called. Many users are not familiar with these codes or their use.

In these situations, some users may simplify dialing by recalling destination numbers in their electronic contact lists that have a universal international access code symbol followed by the phone number in the E.164 standard format for international telephone numbers. At present, the universal international access code symbol is the plus sign (“+”) and the E.164 standard format for international telephone numbers (also called “international ISDN numbers”) is specified in the E.164 recommendation of the ITU. For example, a destination number in the United States would have the following format:

+1 123 456 7890

where

“+” is the universal international access code symbol,

1 is the country code for the United States, and

123 456 7890 is the number in the United States, with 123 representing an area/city/trunk code and 456 7890 representing a subscriber number.

Similarly, a destination number in Germany would have the following for format:

+49 123 456 7890

where

“+” is the universal international access code symbol,

49 is the country code for Germany, and

123 456 7890 is the number in Germany, with 123 representing an area/city/trunk code and 456 7890 representing a subscriber number.

However, many users do not store phone numbers in this format on their mobile communications device, e.g., because they are seldom outside their home country, seldom make international calls, and/or are unaware of the universal international access code symbol and its use. Moreover, users often need to make calls to numbers that are not stored on their communications devices.

Accordingly, there is a need for simpler, more transparent methods and user interfaces for dialing from portable communication devices, particularly when the user is located outside his/her home country and/or is trying to dial a destination number outside his/her home country.

### SUMMARY

The above deficiencies and other problems associated with dialing from portable communications devices are reduced or eliminated by the disclosed method, device and graphical user interface.

One aspect of the invention involves a computer-implemented method in which a portable communications device receives from a user a first sequence of symbols that includes a phone number that corresponds to a destination number for a call. If the first sequence of symbols includes a predefined universal international access code symbol followed by the phone number, the portable communications device sends an address message corresponding to the first sequence of symbols to a communications network. However, if the first sequence of symbols does not include the predefined universal international access code symbol followed by the phone number, the portable communications device determines a second sequence of symbols that correspond to the destination number, wherein the second sequence of symbols includes the predefined universal international access code symbol if the portable communications device is presently located in a country other than the home country of the portable communications device, and sends an address message corresponding to the second sequence of symbols to the communications network.

Another aspect of the invention involves a graphical user interface on a portable communications device that includes a second sequence of symbols that corresponds to a destination number for a call. The second sequence of symbols is determined by the portable communications device based on a first sequence of symbols, without a predefined universal international access code symbol, that includes a phone number that corresponds to the destination number. The second sequence of symbols includes the predefined universal international access code symbol. An address message corresponding to the second sequence of symbols is sent to a communications network.

Another aspect of the invention involves a portable communications device. The portable communications device includes one or more processors, memory, and one or more programs. The one or more programs are stored in the memory and configured to be executed by the one or more processors. The one or more programs include: instructions for receiving from a user a first sequence of symbols that includes a phone number that corresponds to a destination number for a call; instructions, utilized when the first sequence of symbols includes a predefined universal international access code symbol followed by the phone number, for sending an address message corresponding to the first sequence of symbols to a communications network; and instructions, utilized when the first sequence of symbols does not include the predefined universal international access code symbol followed by the phone number, for determining a second sequence of symbols that correspond to the destination number, and for sending an address message corresponding to the second sequence of symbols to the communications network. The second sequence of symbols includes the predefined universal international access code symbol if the portable communications device is presently located in a country other than the home country of the portable communications device,

Another aspect of the invention involves a computer-program product that includes a computer readable storage medium and a computer program mechanism embedded therein. The computer program mechanism includes instructions, which when executed by a portable communications device, cause the device to perform a set of operations, including receiving from a user a first sequence of symbols that includes a phone number that corresponds to a destination number for a call. If the first sequence of symbols includes a predefined universal international access code symbol followed by the phone number, the instructions cause the portable communication device to send an address message corresponding to the first sequence of symbols to a communications network; and if the first sequence of symbols does not include the predefined universal international access code symbol followed by the phone number, the instructions cause the portable communication device to determine a second sequence of symbols that correspond to the destination number, wherein the second sequence of symbols includes the predefined universal international access code symbol if the portable communications device is presently located in a country other than the home country of the portable communications device, and to send an address message corresponding to the second sequence of symbols to the communications network.

Another aspect of the invention involves a portable communications device that has means for receiving from a user a first sequence of symbols that includes a phone number that corresponds to a destination number for a call. The device also has means, utilized when the first sequence of symbols includes a predefined universal international access code symbol followed by the phone number, for sending an address message corresponding to the first sequence of symbols to a communications network; means, utilized when the first sequence of symbols does not include the predefined universal international access code symbol followed by the phone number, for determining a second sequence of symbols that correspond to the destination number, wherein the second sequence of symbols includes the predefined universal international access code symbol if the portable communications device is presently located in a country other than the home country of the portable communications device; and means for sending an address message corresponding to the second sequence of symbols to the communications network.

Thus, the invention makes dialing from portable communications devices simpler and more intuitive, particularly when the user is located outside his/her home country and/or is trying to dial a destination number outside his/her home country.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is a block diagram illustrating a portable communications device in accordance with some embodiments of the invention.

FIGS. 2A and 2B are schematic diagrams illustrating a portable communication device 100 in accordance with some embodiments of the invention.

FIGS. 3A and 3B are flow diagrams illustrating dialing processes in accordance with some embodiments of the invention.

FIG. 4 is a flow diagram illustrating a process for determining a second sequence of symbols that correspond to a destination number in accordance with some embodiments of the invention.

FIGS. 5A-5M illustrate exemplary graphical user interfaces for dialing in accordance with some embodiments of the invention.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, circuits, and networks have not been described in detail so as not to unnecessarily obscure aspects of the embodiments.

Embodiments of user interfaces and associated processes for using a portable communications device are described. The user interface may include a click wheel and/or touch screen. A click wheel is a physical user-interface device that may provide navigation commands based on an angular displacement of the wheel or a point of contact with the wheel by a user of the device. A click wheel may also be used to provide a user command corresponding to selection of one or more items, for example, when the user of the device presses down on at least a portion of the wheel or the center of the wheel. For simplicity, in the discussion that follows, a portable communications device (e.g., a cellular telephone that may also contain other functions, such as PDA and music player functions) that includes a click wheel is used as an exemplary embodiment. It should be understood, however, that the user interfaces and associated processes may be applied to other devices, such as personal computers and laptops, that may include one or more other physical user-interface devices, such as a keyboard, a mouse, a joystick, and/or a touch screen. It is also noted that while a click wheel is a physical user-interface device, a virtual click wheel can be implemented on a touch screen, and thus the term “click wheel” is used herein to encompass both physical click wheels and virtual click wheels.

The device may support a variety of applications, such as telephone, text messenger and a music player. The music player may be compatible with one or more file formats, such as MP3 and/or AAC. In an exemplary embodiment, the device includes an iPod music player (trademark of Apple Computer, Inc.).

The various applications that may be executed on the device may use at least one common physical user-interface device, such as the click wheel. One or more functions of the click wheel as well as corresponding information displayed on the device may be adjusted and/or varied from one application to the next and/or within a respective application. In this way, a common physical architecture (such as the click wheel) of the device may support the variety of applications with user interfaces that are intuitive and transparent.

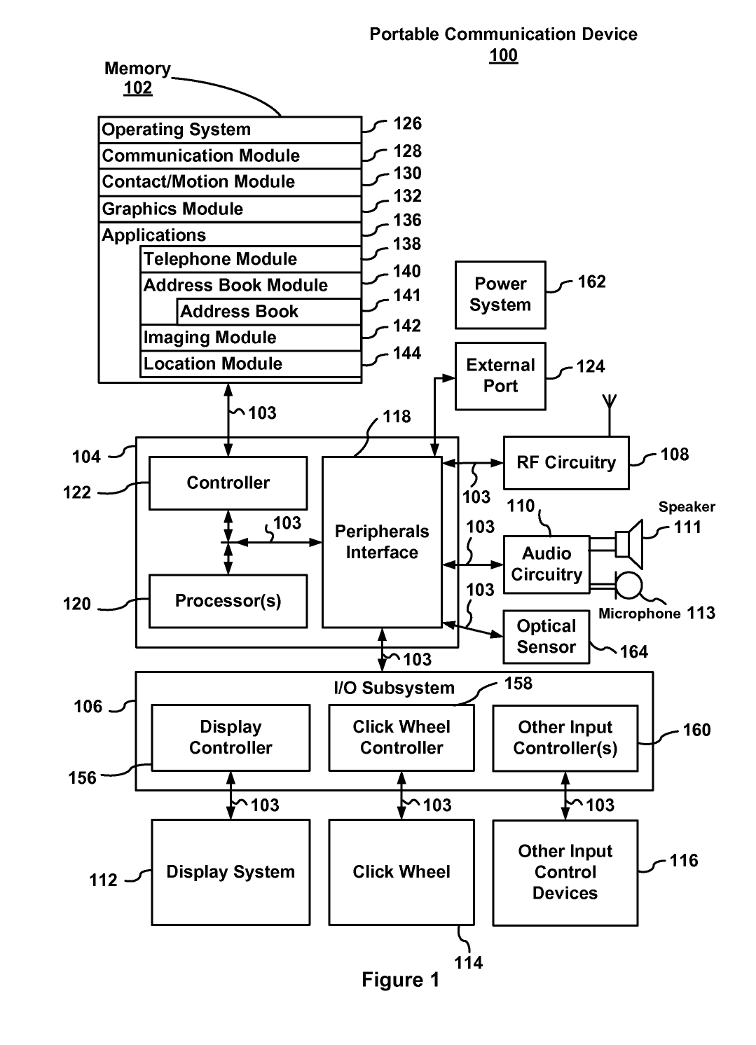

Attention is now directed towards embodiments of the device. FIG. 1 is a block diagram illustrating an architecture for a portable communication device 100, according to some embodiments of the invention. The device 100 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, a display system 112 (which may include a touch screen), a click wheel 114, other input or control devices 116, and an external port 124. For convenience, the display system 112 is sometimes herein called a touch screen or touch-sensitive screen or touch-sensitive display. The device 100 may optionally include optical sensors 164. These components may communicate over one or more communication buses or signal lines 103. The device 100 may be any portable electronic device, including but not limited to a handheld computer, a tablet computer, a laptop computer, a mobile phone, a media player, a personal digital assistant (PDA), or the like, including a combination of two or more of these items, provided the device includes voice and/or video communication capabilities (e.g., for voice calls or video calls). In other embodiments, the device 100 may not be portable, such as a desktop personal computer.

It should be appreciated that the device 100 is only one example of a portable communications device 100, and that the device 100 may have more or fewer components than shown, may combine two or more components, or a may have a different configuration or arrangement of the components. The various components shown in FIG. 1 may be implemented in hardware, software or a combination of both hardware and software, including one or more signal processing and/or application specific integrated circuits.

Memory 102 may include high speed random access memory and may also include non-volatile memory, such as one or more magnetic disk storage devices, flash memory devices, or other non-volatile solid state memory devices. In some embodiments, memory 102 may further include storage remotely located from the one or more processors 120, for instance network attached storage accessed via the RF circuitry 108 or the external port 124 and a communications network (not shown) such as the Internet, intranet(s), Local Area Networks (LANs), Wide Local Area Networks (WLANs), Storage Area Networks (SANs) and the like, or any suitable combination thereof. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the device 100 and to process data.

In some embodiments, the peripherals interface 118, the CPU 120, and the memory controller 122 may be implemented on a single chip, such as a chip 104. In some other embodiments, they may be implemented on separate chips.

The RF (radio frequency) circuitry 108 receives and sends RF signals, also called electromagnetic signals. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document.

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. In some embodiments, the audio circuitry 110 also includes a headset jack (not shown). The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the display system 112, the click wheel 114 and other input/control devices 116, to the peripherals interface 118. The I/O subsystem 106 may include a display controller 156, a click wheel controller 158 and one or more input controllers 160 for other input or control devices. The one or more input controllers 160 receive/send electrical signals from/to other input or control devices 160. The other input/control devices 160 may include physical buttons (e.g., push buttons, rocker buttons, etc.), dials, slider switches, joysticks, and so forth.

The display system 112 provides an output interface and/or an input interface between the device and a user. The display controller 156 receives and/or sends electrical signals from/to the display system 112. The display system 112 displays visual output to the user. The visual output may include text, icons, graphics, video, and any combination thereof. In some embodiments, some or all of the visual output may correspond to user-interface objects, further details of which are described below.

In some embodiments, such as those that include a touch screen, the display system 112 also accepts input from the user based on haptic and/or tactile contact. In embodiments with a touch screen, the display system 112 forms a touch-sensitive surface that accepts user input. In these embodiments, the display system 112 and the display controller 156 (along with any associated modules and/or sets of instructions in memory 102) detect contact (and any movement or breaking of the contact) on the display system 112 and converts the detected contact into interaction with user-interface objects, such as one or more soft keys, that are displayed on a touch screen. In an exemplary embodiment, a point of contact between a touch screen in the display system 112 and the user corresponds to one or more digits of the user.

In embodiments with a touch screen, the touch screen in the display system 112 may use LCD (liquid crystal display) technology, or LPD (light emitting polymer display) technology, although other display technologies may be used in other embodiments. A touch screen in the display system 112 and the display controller 156 may detect contact and any movement or breaking thereof using any of a plurality of touch sensing technologies, including but not limited to capacitive, resistive, infrared, and surface acoustic wave technologies, as well as other proximity sensor arrays or other elements for determining one or more points of contact with a touch screen in the display system 112. A touch-sensitive display in some embodiments of the display system 112 may be analogous to the multi-touch sensitive tablets described in the following U.S. patents: U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference. However, a touch screen in the display system 112 displays visual output from the portable device 100, whereas touch sensitive tablets do not provide visual output. The touch screen in the display system 112 may have a resolution in excess of 100 dpi. In an exemplary embodiment, the touch screen in the display system has a resolution of approximately 168 dpi. The user may make contact with the touch screen in the display system 112 using any suitable object or appendage, such as a stylus, a digit, and so forth.

A touch-sensitive display in some embodiments of the display system 112 may be as described in the following applications: (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005; and (9) U.S. patent application Ser. No. 11/367,749, “Multi-Functional Hand-Held Device,” filed on Mar. 3, 2006. All of these applications are incorporated by reference herein.

In some embodiments, in addition to the touch screen of the display system 112, the device 100 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the display system 112 (also called a touch screen) or an extension of the touch-sensitive surface formed by the touch screen.

The device 100 may include a click wheel 114. A user may navigate among one or more graphical objects (henceforth referred to as icons) displayed in the display system 112 by rotating the click wheel 114 or by moving (e.g., angular displacement) a point of contact with the click wheel 114. The click wheel 114 may also be used to select one or more of the displayed icons. For example, the user may press down on at least a portion of the click wheel 114 or an associated physical button. User commands and navigation commands provided by the user via the click wheel 114 may be processed by the click wheel controller 158 as well as one or more of the modules and/or sets of instructions in memory 102.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 100 may also include one or more optical sensors 164. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 142, the optical sensor 164 may capture still images or video.

In some embodiments, the software components stored in memory 102 may include an operating system 126, a communication module (or set of instructions) 128, a contact/motion module (or set of instructions) 130, a graphics module (or set of instructions) 132, and one or more applications (or set of instructions) 136. The applications module 136 may include a telephone module (or set of instructions) 138, an address book module (or set of instructions) 140, an imaging module (or set of instructions) 142, and/or a location module (or set of instructions) 144.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.).

The contact/motion module 130 may detect contact with the click wheel 114 and/or a touch screen in the display system 112 (in conjunction with the display controller 156). The contact/motion module 130 includes various software components for performing various operations related to detection of contact, such as determining if contact has occurred, determining if there is movement of the contact and tracking the movement across the click wheel 114 and/or a touch screen in the display system 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. In some embodiments, the contact/motion module 130 and the display controller 156 also detects contact on a touchpad.

The graphics module 132 includes various known software components for rendering and displaying graphics on the display system 112, including components for changing the intensity of graphics that are displayed. Note that the term “graphics” includes any object that can be displayed to a user, including without limitation text, web pages, icons (such as user-interface objects including soft keys), digital images, videos, animations and the like.

In addition to the telephone module 138, the address book module 140, the imaging module 142, and/or the location module 144, the one or more applications 136 may include any applications installed on the device 100, including without limitation, a browser, email, instant messaging, text messaging, word processing, keyboard emulation, widgets, JAVA-enabled applications, encryption, digital rights management, voice recognition, voice replication, etc.

In conjunction with the RF circuitry 108, the audio circuitry 110, the speaker 111, the microphone 113, the display system 112, the display controller 156, the click wheel 114 and/or the click wheel controller 158, the telephone module 138 may be used to enter a sequence of characters corresponding to a telephone number, access one or more telephone numbers in the address book 141, modify a telephone number that has been entered, dial a respective telephone number, conduct a conversation and disconnect or hang up when the conversation is completed.

In conjunction with the display system 112, the display controller 156, the click wheel 114 and/or the click wheel controller 158, the address book module 140 may be used to manage an address book or contact list 141, including adding a name to the address book 141, deleting a name from the address book 141, associating a phone number or other information with a name, associating an image with a name, categorizing and sorting names, and so forth.

In conjunction with the display system 112, the display controller 156, the click wheel 114, the click wheel controller 158, and the optical sensor(s) 164, the imaging module 142 may be used to capture still images or video (including a video stream) and store them into memory 102, modify characteristics of a still image or video, or delete a still image or video from memory 102.

In conjunction with the RF circuitry 108, the location module 144 may be used to determine the approximate location of the portable communications device, e.g., by determining the location of the device in the cellular network or through the use of the Global Positioning System (GPS).

In some embodiments, the device 100 is a device where operation of a predefined set of functions on the device is performed exclusively through a touch screen in the display system 112 and/or a touchpad. By using a touch screen and/or a touchpad as the primary input/control device for operation of the device 100, the number of physical input/control devices (such as push buttons, dials, and the like) on the device 100 may be reduced. In one embodiment, the device 100 includes a touch screen, a touchpad, a push button for powering the device on/off and locking the device, a volume adjustment rocker button and a slider switch for toggling ringer profiles. The push button may be used to turn the power on/off on the device by depressing the button and holding the button in the depressed state for a predefined time interval, or may be used to lock the device by depressing the button and releasing the button before the predefined time interval has elapsed. In an alternative embodiment, the device 100 also may accept verbal input for activation or deactivation of some functions through the microphone 113.

The predefined set of functions that may be performed exclusively through a touch screen and/or a touchpad include navigation between user interfaces. In some embodiments, the touchpad, when touched by the user, navigates the device 100 to a main, home, or root menu from any user interface that may be displayed on the device 100. In such embodiments, the touchpad may be referred to as a “menu button.” In some other embodiments, the menu button may be a physical push button or other physical input/control device instead of a touchpad.

In some embodiments, the device 100 is a device where operation of a predefined set of functions on the device is performed exclusively or primarily through the click wheel 114. By using the click wheel 114 as the primary input/control device for operation of the device 100, the number of other physical input/control devices (such as push buttons, dials, and the like) on the device 100 may be reduced.

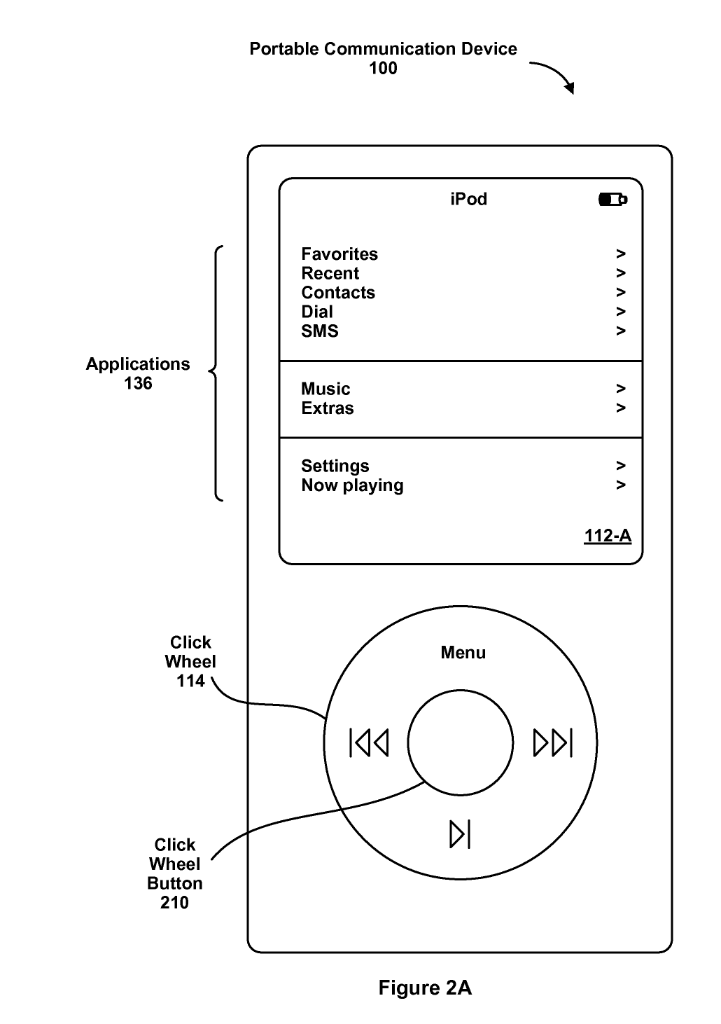

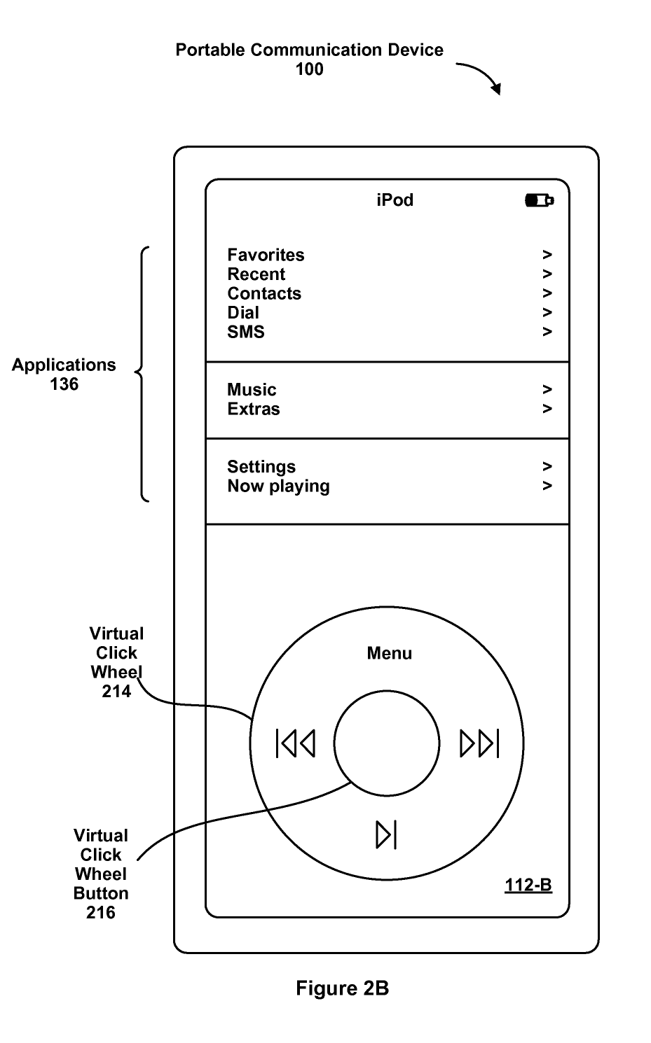

Attention is now directed towards embodiments of user interfaces and associated processes that may be implemented on a portable communications device 100. FIG. 2A is a schematic diagram illustrating a portable communication device 100 in accordance with some embodiments of the invention. The device 100 includes a click wheel 114 and a display 112-A. The click wheel 114 constitutes a physical interface for receiving user commands (such as selection of one of more items and/or icons that are displayed on the display 112-A) and/or navigation commands (which may, for example, control scrolling through the items and/or icons that are displayed on the display 112-A). The user may use the click wheel 114 by touching it (making a point of contact) and then moving the point of contact while maintaining contact. Such angular displacement may indicate a navigation command to scroll through the items and/or icons that are displayed on the display 112-A. By pressing down on the click wheel 114, or on a click wheel button 210 (e.g., at the center of the click wheel), the user may select one or more items and/or icons that are displayed on the display 112-A. Thus, a pressing down gesture may indicate a user command corresponding to selection. In some embodiments, pressing down on the click wheel button 210 initiates sending a phone number to a communications network.

The device 100 may display a menu, set, or hierarchy of applications that may be executed or run on the device 100. For example, the displayed menu or hierarchy for the applications may include ‘Favorites’ for popular applications for this user, ‘Recent’ for calls that have been made, answered, and/or missed within a first pre-determined time period (such as the last day, week or month), ‘Contacts’ (which corresponds to the address book 141 in FIG. 1), ‘Dial’ (which corresponds to the telephone module 138 in FIG. 1) and ‘SMS’ (which corresponds to a Short Messaging Service application, not shown in FIG. 1). The menu or hierarchy may also optionally include ‘Music’, ‘Extras’, ‘Settings’ and ‘Now playing’ icons that correspond to a music player module. The display 112-A may also convey other information, such as an icon that indicates a remaining stored power level for the device 100.

FIG. 2B shows another embodiment of the device 100 in which the display 112 (now 112-B) includes a virtual click wheel 214 with a virtual click wheel button 216. From the viewpoint of the user, this embodiment of device 100 works virtually identically to the embodiment of the device shown in FIG. 2A, except that user gestures (taps, swipes, and so on) on the virtual click wheel 214 and its virtual click wheel button 216 are used in place of similar user gestures on the click wheel 114 and click wheel button 210 of the embodiment shown in FIG. 2A. Internally, the circuitry and control software of the embodiment of the device 100 shown in FIG. 2B detects and converts user gestures on the virtual click wheel 214 and virtual click wheel button 216 into commands that correspond to commands associated with user manipulation of the click wheel 114 and click wheel button 210 of the device 100 embodiment shown in FIG. 2A.

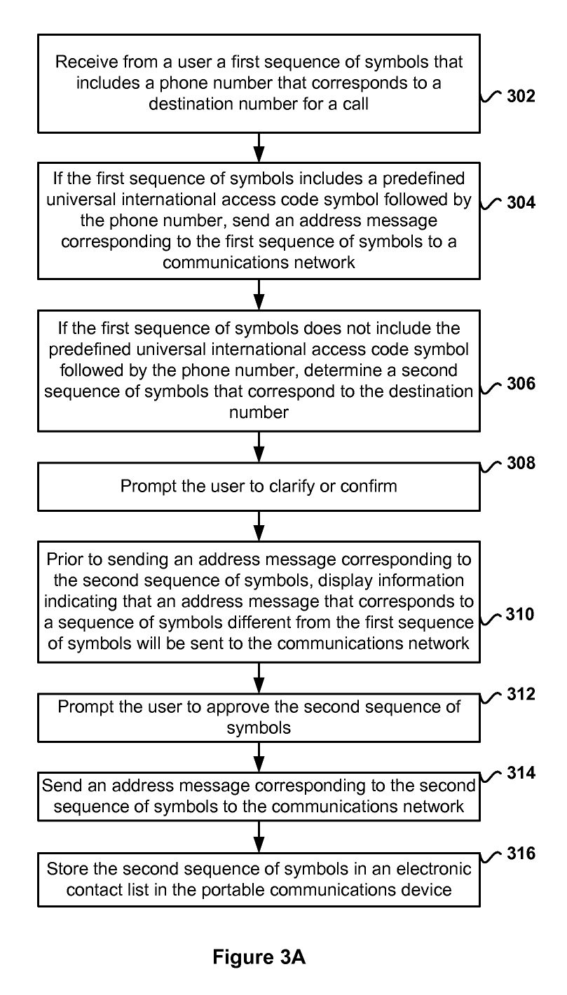

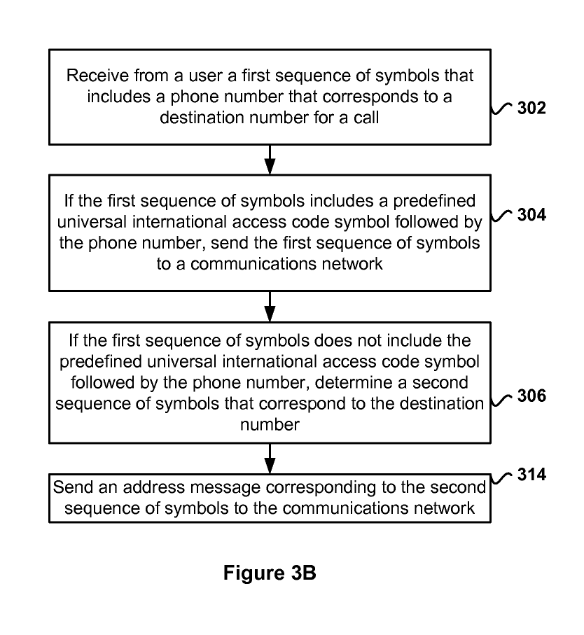

FIGS. 3A and 3B are flow diagrams illustrating dialing processes in accordance with some embodiments of the invention. The processes shown in FIGS. 3A and 3B (or subsets or supersets thereof) may be performed by a portable communications device, such as device 100. It will be appreciated by those of ordinary skill in the art that one or more of the acts described may be performed by hardware, software, or a combination thereof.

Referring to FIGS. 3A and 3B, the device receives from a user a first sequence of symbols that includes a phone number that corresponds to a destination number for a call (302). In some embodiments, the input is received via a click wheel 114, touch screen, or other input control device 116. In some embodiments, the call is a voice call or a video call.

If the first sequence of symbols includes a predefined universal international access code symbol followed by the phone number, a corresponding address message is sent (304) to a communications network. For example, if the first sequence of symbols is +49 123 456 7890, then what is sent to a communications network is an address message corresponding to the first sequence of symbols, which has the following information: {TON=1, dest_addr=491234567890}, where TON=1 means that the “type of number” being called is an international number, also called the “ISDN TON.” In this example, a call is made to the number 123 456 7890 in Germany. In some embodiments, the international telephone number message is sent via RF circuitry 108 in conjunction with communication module 128 and telephone module 138. At present, the predefined universal international access code symbol is a plus sign (“+”). This universal international access code symbol may be changed to another symbol at some point in the future, even though such a change is not likely to occur.

If the first sequence of symbols does not include the predefined universal international access code symbol followed by the phone number, a second sequence of symbols that correspond to the destination number is determined (306). In some embodiments, the second sequence of symbols is determined by telephone module 138 in conjunction with location module 144 and address book module 140. The second sequence of symbols includes the predefined universal international access code symbol if the portable communications device is presently located in a country other than the home country of the portable communications device. In some embodiments, the destination number in the second sequence of symbols is an international ISDN number, which means that it conforms to the E.164 international numbering plan for public telephone systems. In the E.164 international numbering plan, each address (also called an assigned telephone number) contains a country code (CC), a national destination code (NDC), and a subscriber number (SN). There can be up to 15 digits in an E.164 number. The E.164 plan was originally developed by the International Telecommunication Union (ITU). With E.164, each address is unique worldwide.

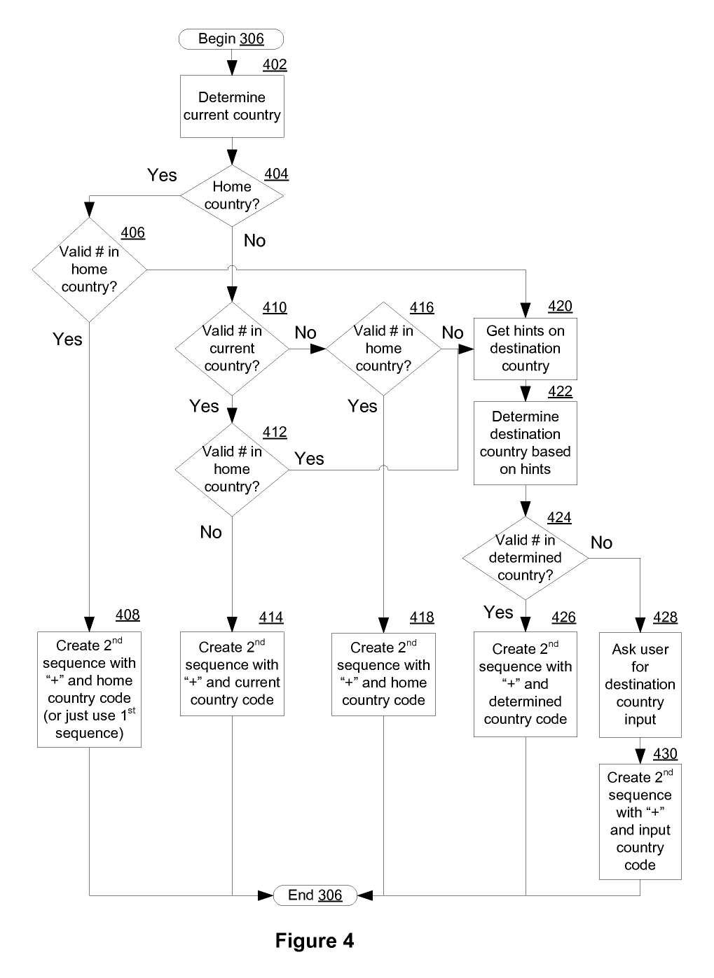

FIG. 4 is a flow diagram illustrating a process for determining (306) a second sequence of symbols that correspond to a destination number in accordance with some embodiments of the invention. The processes shown in FIG. 4 (or subsets or supersets thereof) may be performed by a portable communications device, such as device 100. It will be appreciated by those of ordinary skill in the art that one or more of the acts described may be performed by hardware, software, or a combination thereof. In addition, it will be appreciated by those of ordinary skill in the art that some of the processes shown in FIG. 4 (or subsets or supersets thereof) can be performed in a different order. In some embodiments, determining the second sequence of symbols is based on the home country of the portable communications device and the country in which the portable communications device is presently located.

The current country, i.e., the country in which the device 100 is currently located, is determined (402). In some embodiments, the current country is determined by location module 144 in conjunction with RF circuitry 108.

If the device is located (404) in its home country (i.e., the country corresponding to the country code in the phone number of the device) and the first sequence of symbols is a valid phone number in the home country (406), then a second sequence of symbols is created (408) that includes the predefined universal international access code symbol (“+”) and the home country code. Alternatively, in some embodiments, the second sequence of symbols is just the first sequence of symbols if the portable communications device is presently located in the home country and the first sequence of symbols is a valid destination number in the home country. In some embodiments, to determine if a number is valid in the home country, the number checked for valid format (e.g., number of digits), for valid area code (or city code), and for valid format for that area/city code. For some jurisdictions (countries or cities or regions), certain digits cannot occur in certain locations of valid destination numbers, while in some jurisdictions certain digits are required to appear in certain locations of valid destination numbers. These requirements may be called local validation rules. In some embodiments the destination number is checked to determine that it complies with some or all of the applicable local validation rules, if any.

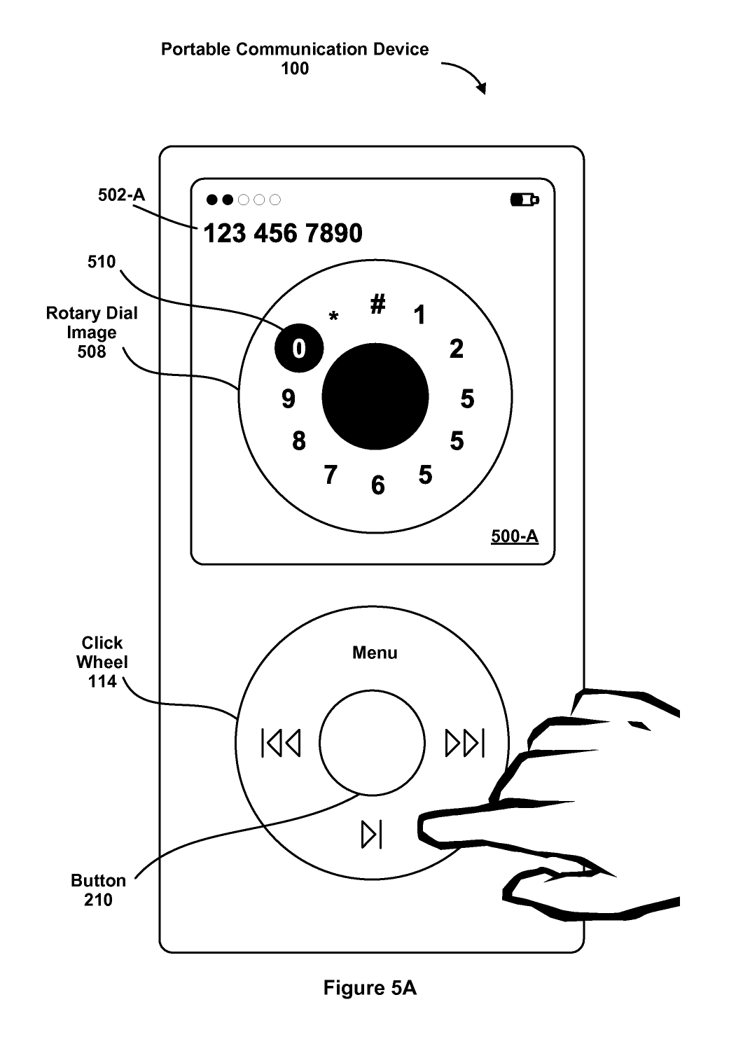

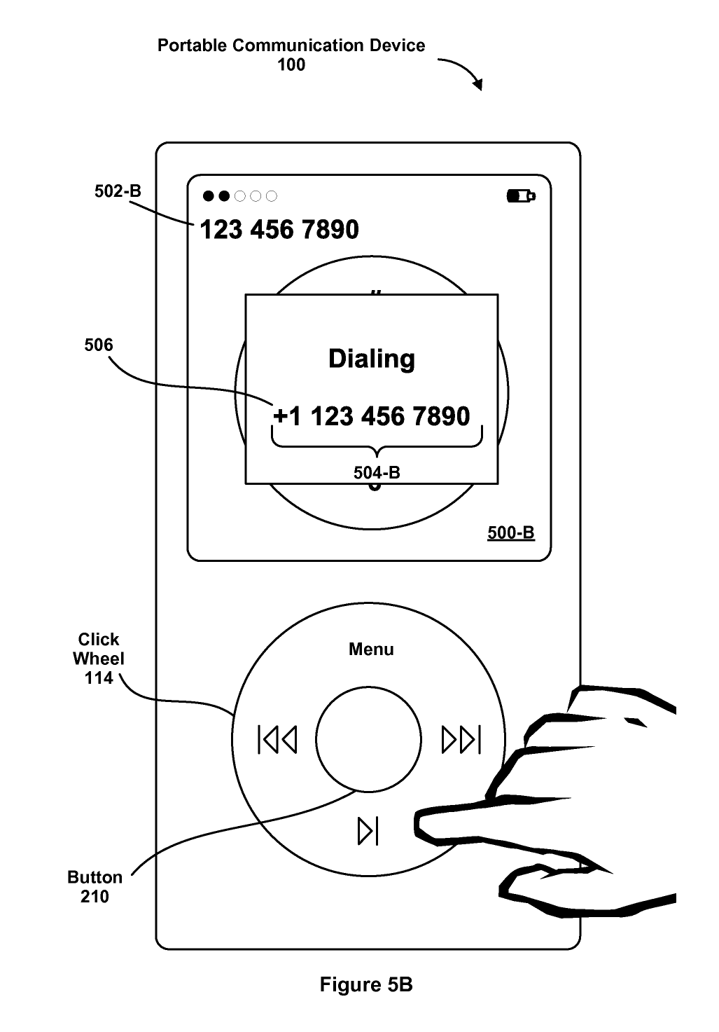

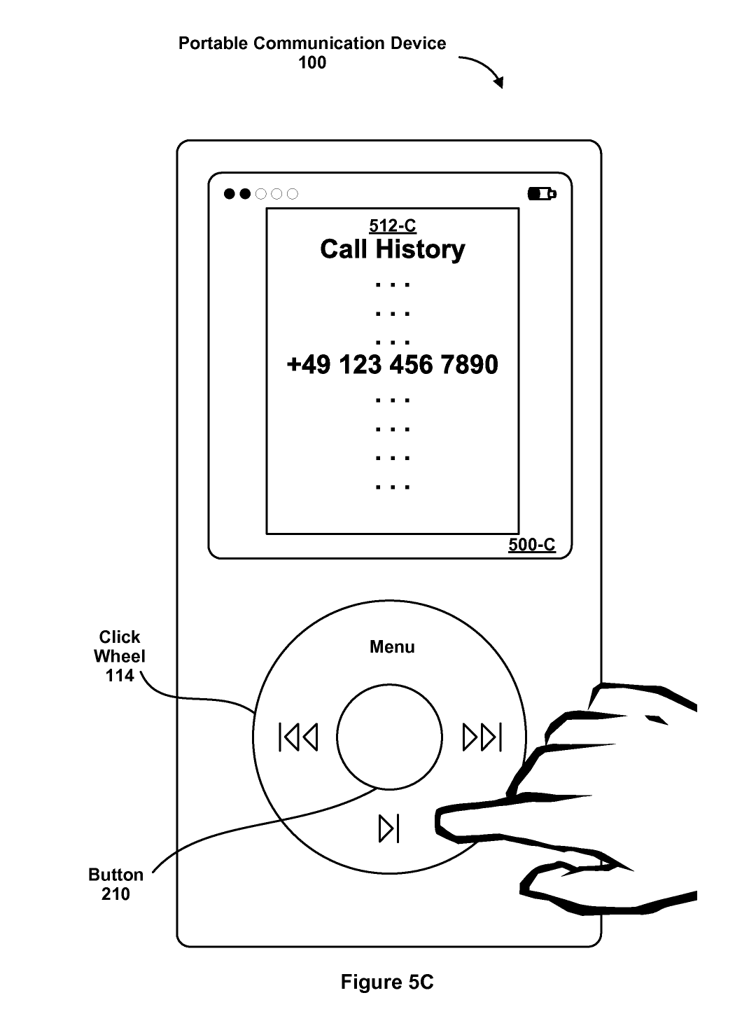

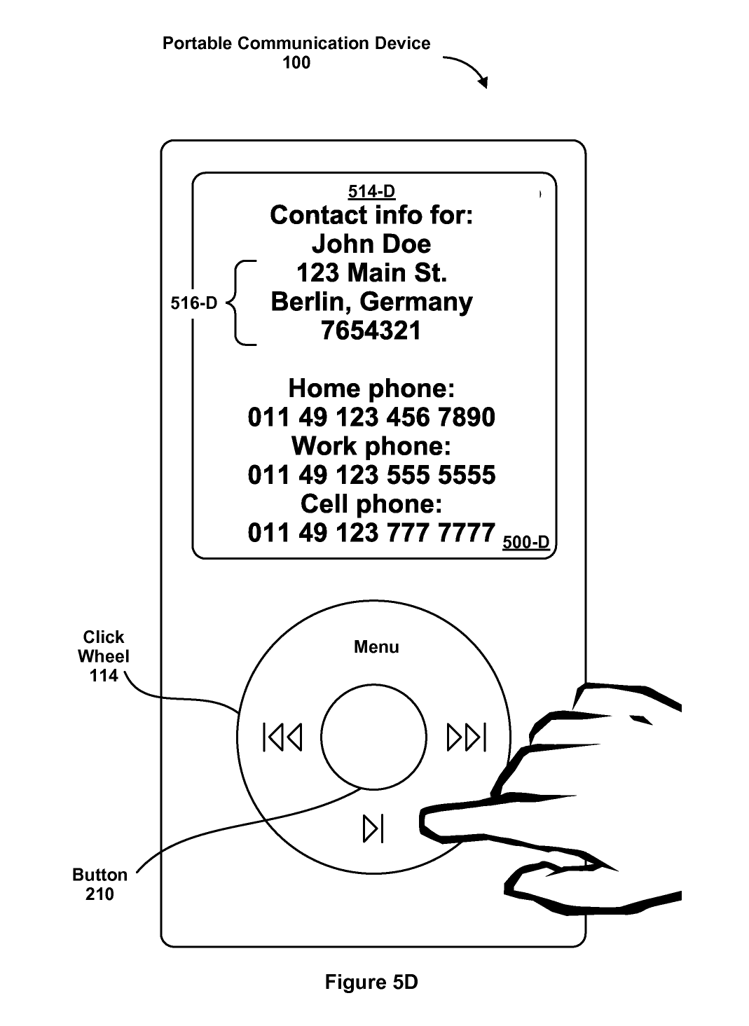

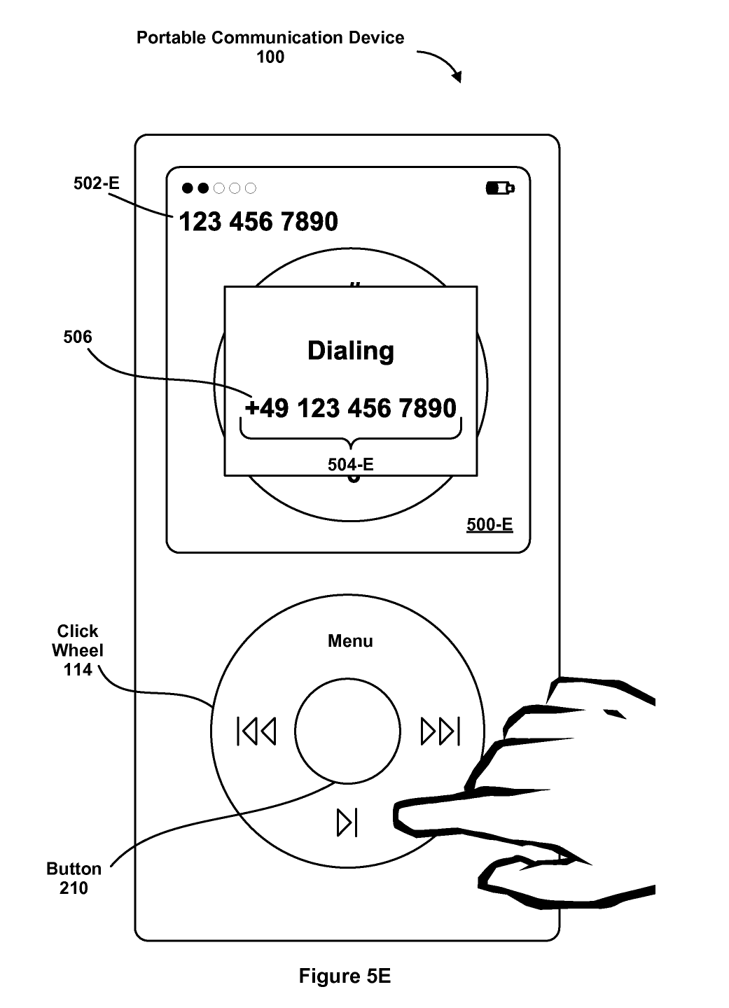

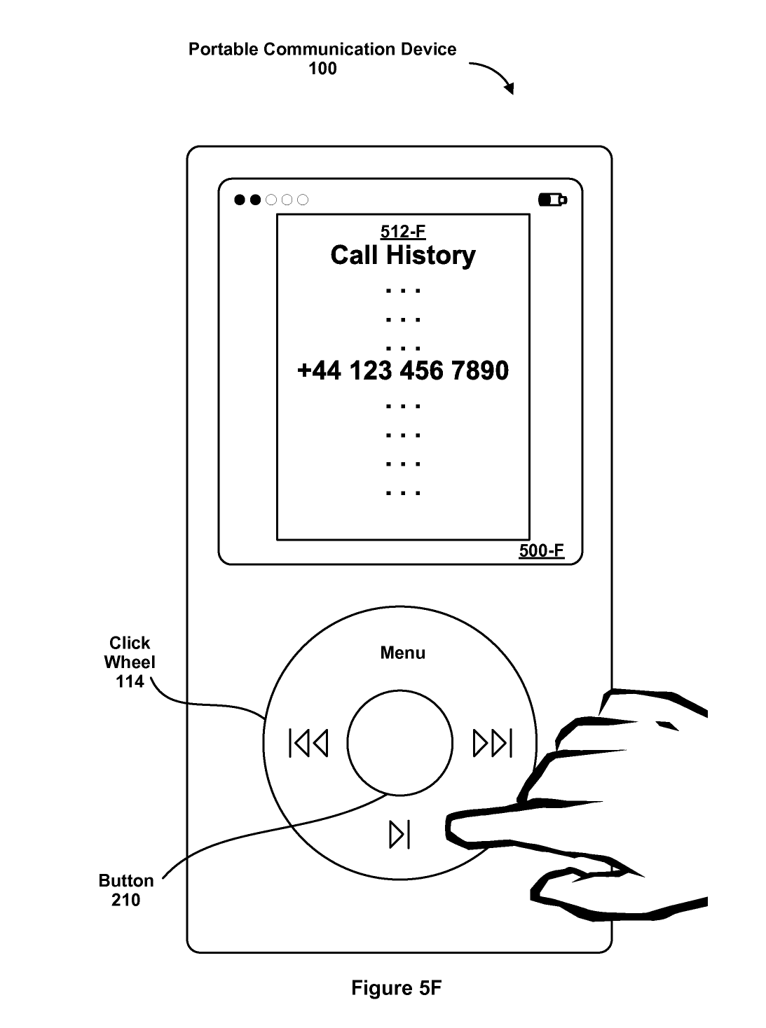

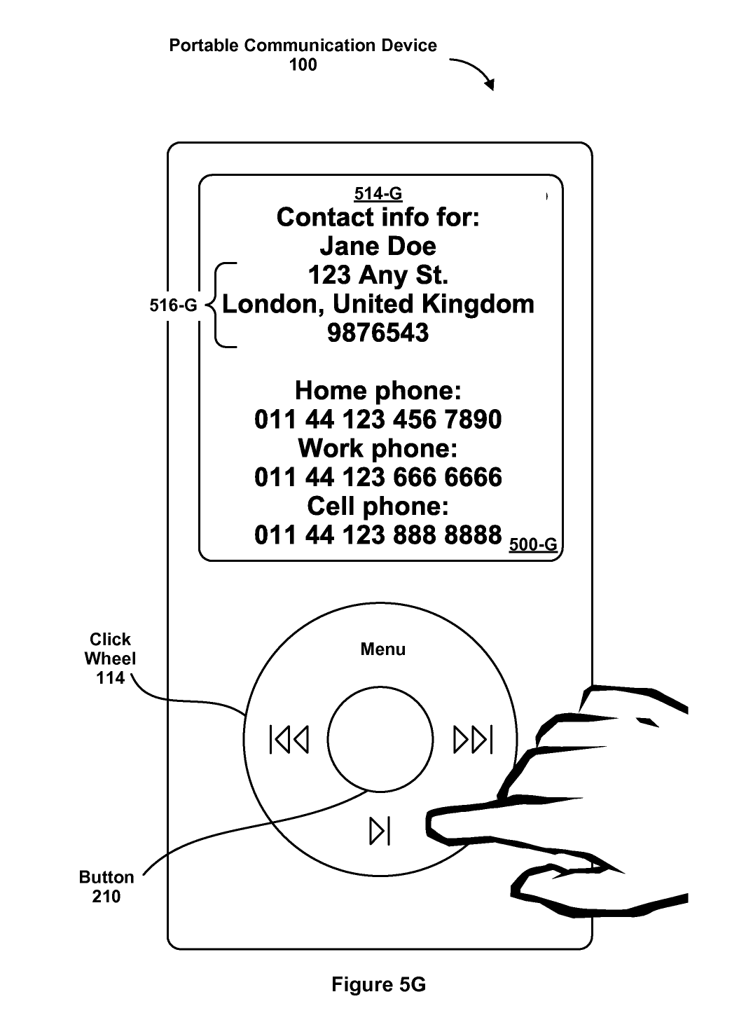

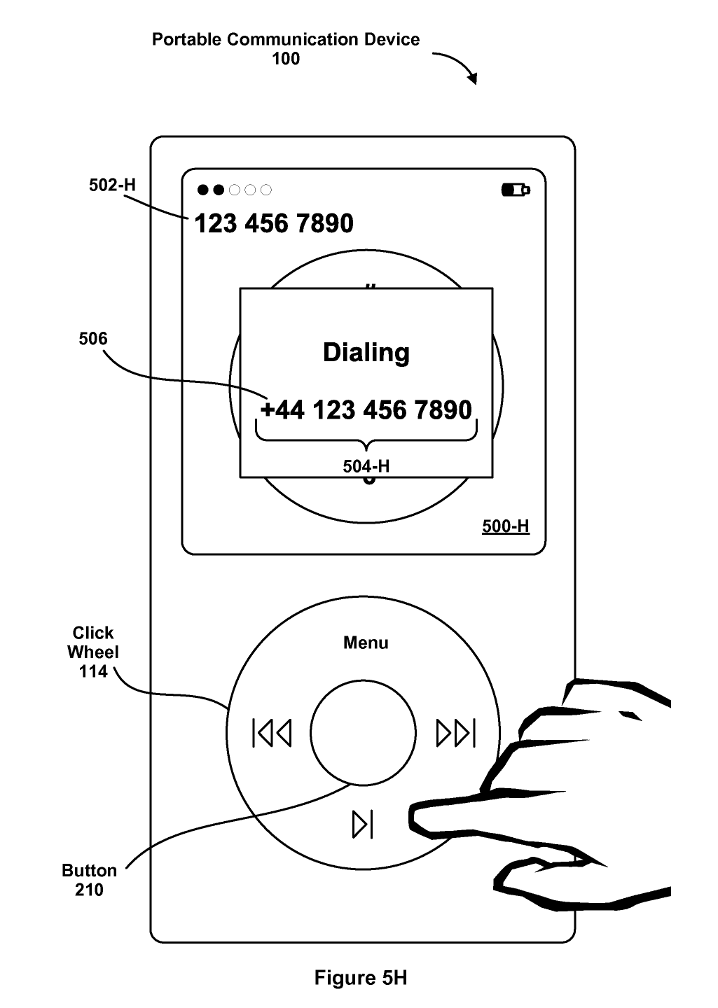

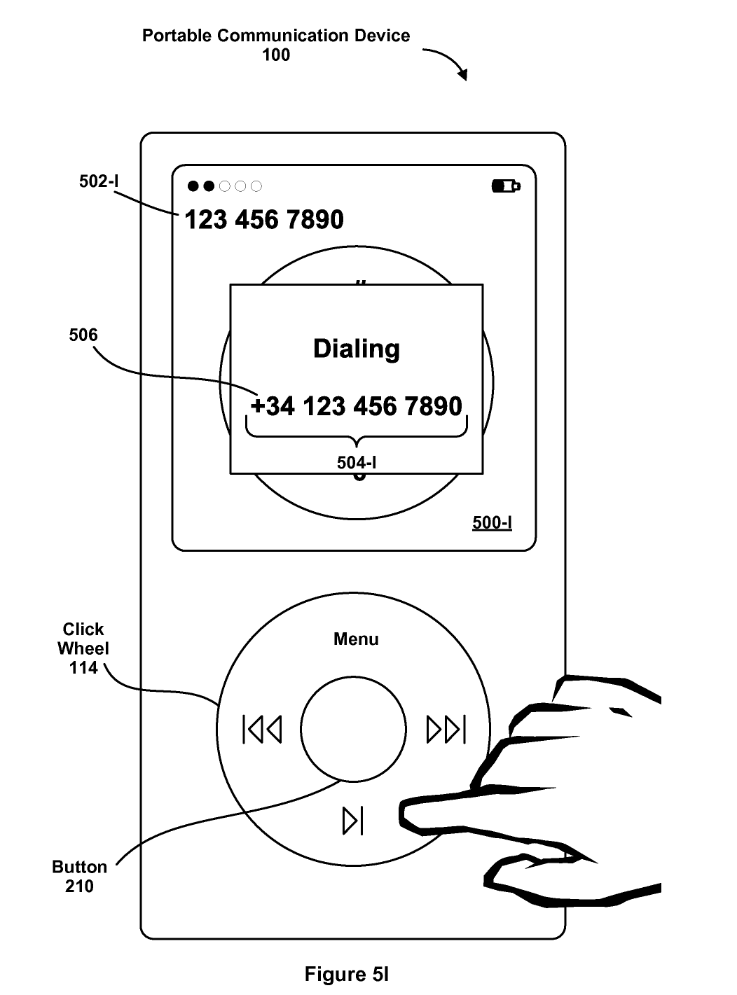

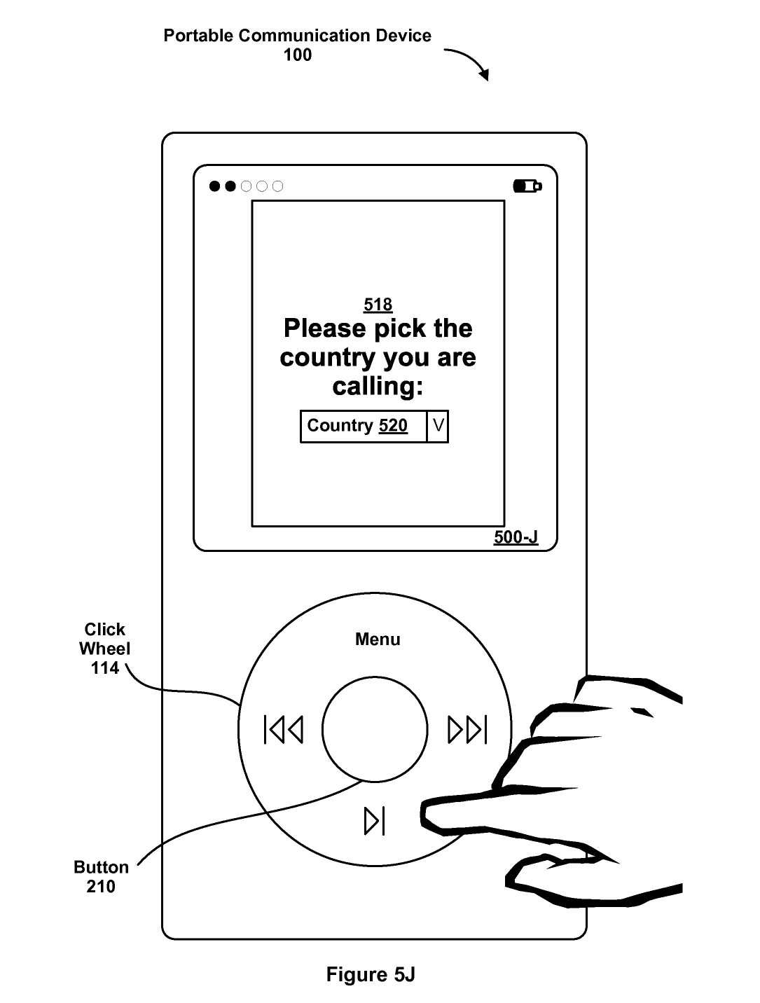

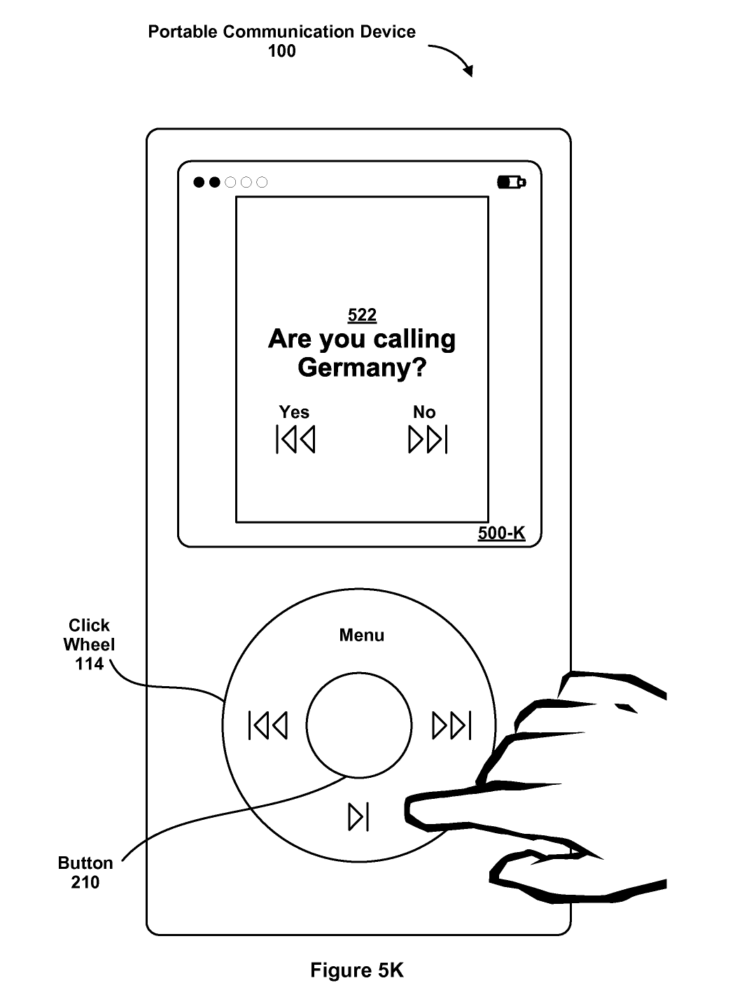

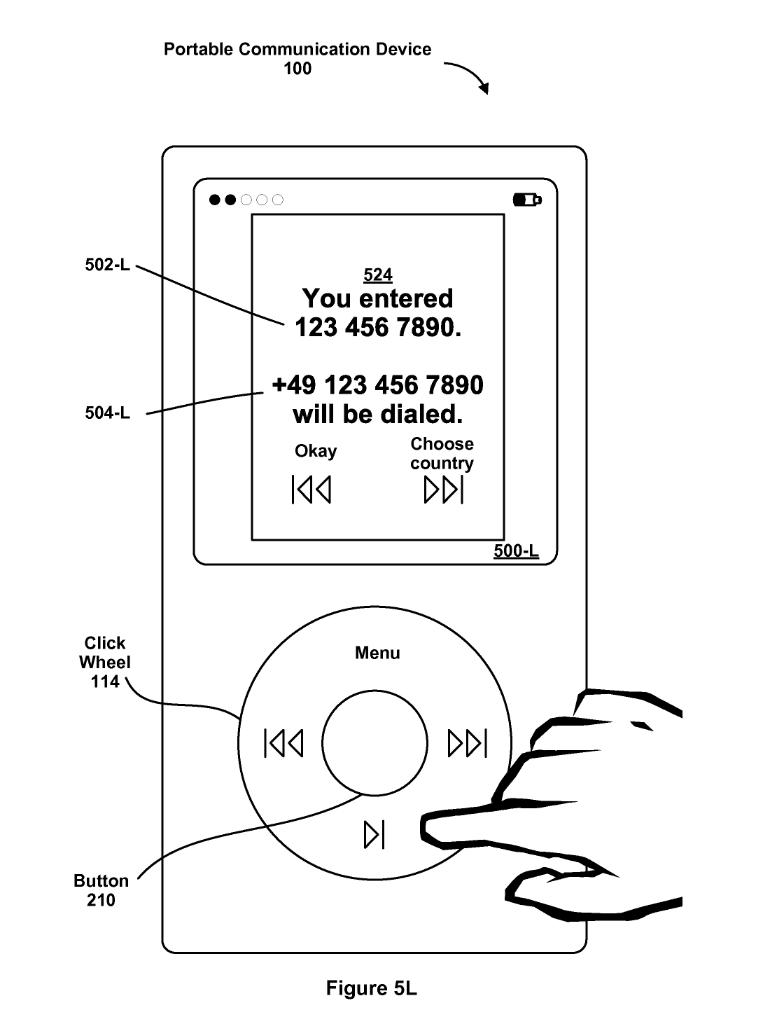

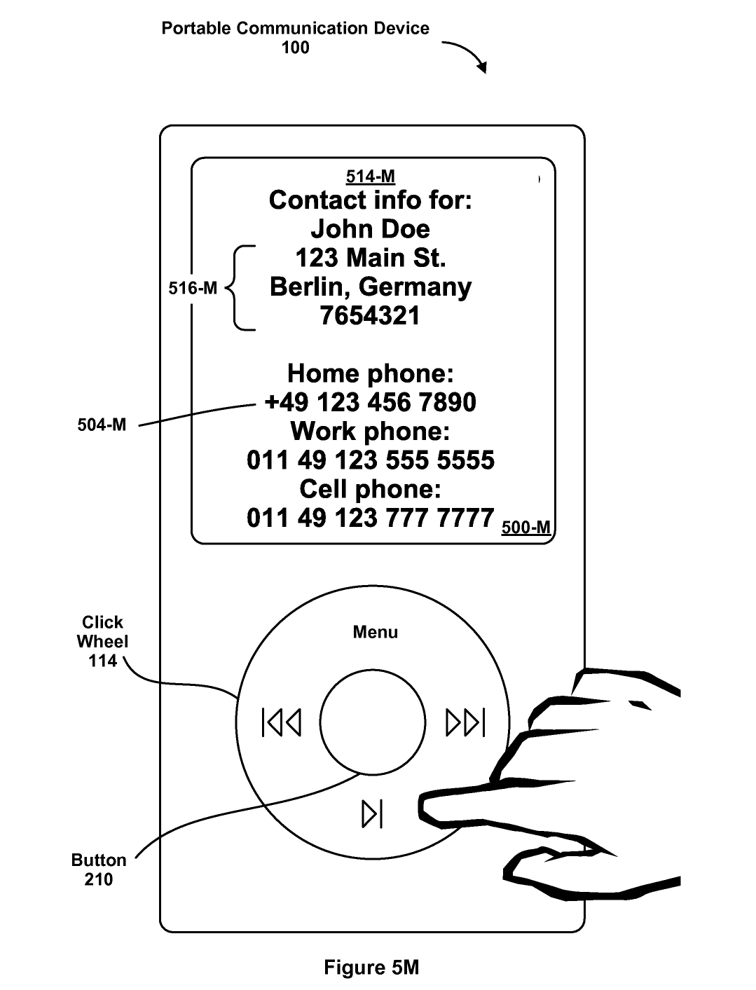

For example, if a user in the United States dials another number in the United States (e.g., 123 456 7890, FIG. 5A), then the second sequence of symbols may be +1 123 456 7890 (FIG. 5B) or, alternatively, just 123 456 7890.

If the device is located (404) in its home country and the first sequence of symbols is not a valid phone number in the home country (406), then hints on the destination country are obtained (420) and the destination country is determined (422) based on the hints. In some embodiments, hints may be determined by examining a call history of the user and/or examining address data in a contact list entry (e.g., in address book 141) that includes the first sequence of symbols.

For example, if a user in the United States dials a number (e.g., 123 456 7890, FIG. 5A) that is not a valid number in the United States, then the telephone module 138 may examine the call history of the device to determine the destination country for a previous call to 123 456 7890 (FIG. 5C). In some embodiments, the telephone module 138 may examine the address book module of the device to determine the destination country for a contact in the address book that has the phone number 123 456 7890 (FIG. 5D). In yet other embodiments, the dialed number may be parsed to identify the digit or digits, if any, most likely to be representative of a country code, and then the country code may be mapped to a destination country.

If the device is not located (404) in its home country, the first sequence of symbols is a valid phone number in the current country (410), and the first sequence of symbols is not a valid phone number in the home country (412), then a second sequence of symbols is created (414) that includes the predefined universal international access code symbol (“+”) and the current country code. In some embodiments, the second sequence of symbols includes a country code for the country in which the portable communications device is presently located if the portable communications device is not presently located in the home country and the first sequence of symbols is not a valid destination number in the home country.

For example, if a US user presently in Germany (404) dials a number that is valid in Germany (e.g., 123 456 7890, FIG. 5A) (410), but not valid in the United States (412), then the second sequence of symbols may be +49 123 456 7890 (FIG. 5E) (414).

If the device is not located (404) in its home country, the first sequence of symbols is a not valid phone number in the current country (410), and the first sequence of symbols is a valid phone number in the home country (416), then a second sequence of symbols is created (418) that includes the predefined universal international access code symbol (“+”) and the home country code. In some embodiments, the second sequence of symbols includes a country code for the home country if the portable communications device is not presently located in the home country and the first sequence of symbols is a valid destination number in the home country. For example, if a US user presently in Germany (404) dials a number that is valid in the United States (e.g., 123 456 7890, FIG. 5A), but not valid in Germany (410, 416), then the second sequence of symbols may be +1 123 456 7890 (FIG. 5B) (418).

If the device is not located (404) in its home country, the first sequence of symbols is a not a valid phone number in the current country (410), and the first sequence of symbols is not a valid phone number in the home country (416), then hints on the destination country are obtained (420) and destination country is determined (422) based on the hints. For example, if a US user presently in Germany (404) dials a number (e.g., 123 456 7890, FIG. 5A) that is not a valid number in either the United States or Germany (410, 416), then the telephone module 138 may examine the call history of the device to determine the destination country for a previous call to a telephone number that includes 123 456 7890 (FIG. 5F) (420). In some embodiments, the telephone module 138 may examine the address book module of the device to determine the destination country for a contact in the address book that has the phone number 123 456 7890 (FIG. 5G).

If the device is not located (404) in its home country, the first sequence of symbols is a valid phone number in the current country (410), and the first sequence of symbols is a valid phone number in the home country (412), then hints on the destination country are obtained (420) and destination country is determined (422) based on the hints. For example, if a US user presently in Germany dials a number (e.g., 123 456 7890, FIG. 5A) that is a valid number in both the United States and Germany, then the telephone module 138 may examine the call history of the device to determine the destination country for a previous call to 123 456 7890 (FIG. 5C). In some embodiments, the telephone module 138 may examine the address book module of the device to determine the destination country for a contact in the address book that has the phone number 123 456 7890 (FIG. 5D).

For cases in which the destination country is determined based on hints (422), if the first sequence of symbols is a valid phone number in the determined destination country (424), then a second sequence of symbols is created (426) that includes the predefined universal international access code symbol (“+”) and the determined destination country code. For example, if the destination country is determined to be the United Kingdom (which has country code 44), then the second sequence of symbols may be +44 123 456 7890 (FIG. 5H).

For cases in which the destination country is determined based on hints (422), if the first sequence of symbols is a not valid phone number in the determined destination country (424), then the user is prompted/asked (428) for input regarding the destination country and a second sequence of symbols is created (430) that includes the predefined universal international access code symbol (“+”) and the country code for the country that corresponds to the input from the user. For example, if the user input (e.g., via a pick list of countries 520) indicates that the destination country is Spain (which has country code 34), then the second sequence of symbols may be +34 123 456 7890 (FIG. 5I).

In some embodiments, determining the second sequence of symbols includes examining a call history of the user (e.g., FIG. 5C or 5F) and/or examining address data in a contact list entry in the portable communications device that includes the first sequence of symbols (e.g., FIG. 5D or 5G). FIGS. 5C, 5D, 5F, and 5G display exemplary call history and contact list information that may be used to determine the second sequence of symbols, but this information may not be shown to the user during the dialing process.

In some embodiments, the user is prompted (308) to clarify or confirm aspects of the call. In some embodiments, the user is prompted to clarify the destination of the call (FIG. 5J). In some embodiments, the user is prompted to confirm the destination of the call (FIG. 5K). In some embodiments, the user is prompted to clarify which country is being called (FIG. 5J). In some embodiments, the user is prompted to confirm the country being called (FIG. 5K).

In some embodiments, prior to sending an address message corresponding to the second sequence of symbols, information is displayed (310) which indicates that an address message that corresponds to a sequence of symbols different from the first sequence of symbols will be sent to the communications network (FIG. 5L). In some embodiments, the second sequence of symbols is displayed. In some embodiments, the user is prompted (312) to approve the second sequence of symbols (FIG. 5L).

An address message corresponding to the second sequence of symbols is sent (314) to the communications network. For example, if the second sequence of symbols is +34 123 456 7890 (FIG. 5I), the address message has the following information: {TON=1, dest_addr=341234567890}, where TON=1 means that the “type of number” being called is an international number. In this example, a call is made to the number 123 456 7890 in Spain. In some embodiments, the address message is sent via RF circuitry 108 in conjunction with communication module 128 and telephone module 138.

In some embodiments, the second sequence of symbols is stored (316) in an electronic contact list in the portable communications device, such as in address book module 140.

In some embodiments, the order of operations 410 and 416 (and the corresponding dependent operations) is reversed, so that testing for a valid number in the home country takes priority over testing for a valid number in the current country. More generally, the order of operations shown in FIG. 4 may be different in other embodiments. Furthermore, some of the operations shown in FIG. 4 may be merged and other operations may be subdivided in other embodiments.

FIGS. 5A-5M illustrate exemplary graphical user interfaces for dialing in accordance with some embodiments of the invention. In some embodiments, these GUIs 500 include the following elements, or a subset or superset thereof:
a first sequence of symbols 502 that includes a phone number that corresponds to a destination number;
a second sequence of symbols 504 that corresponds to a destination number for a call, which includes the predefined universal international access code symbol 506;
a rotary dial image 508 for selecting digits (e.g., 510) with the click wheel 114 (or a soft numeric keypad for entering digits, not shown);
call history 512, which may not be displayed to the user during the dialing process;
contact list entry 514 with address information 516, which may not be displayed to the user during the dialing process;
destination country prompt 518 with country pick list 520;
destination country confirmation 522; and/or
approval prompt 524.

Some GUIs include a second sequence of symbols 504 that corresponds to a destination number for a call (e.g., 500-B, 500-E, 500-H, and 500-I). The second sequence of symbols 504 is determined by the portable communications device 100 based on a first sequence of symbols 502, without a predefined universal international access code symbol 506, that includes a phone number that corresponds to the destination number. The second sequence of symbols 504 includes the predefined universal international access code symbol 506. An address message corresponding to the second sequence of symbols 504 is sent to a communications network.

In some embodiments, if the second sequence of symbols is stored (316), the corresponding contact list entry is updated to have an international ISDN phone number that conforms with the E.164 international numbering plan. For example, compare the phone numbers in FIGS. 5D (011 49 123 456 7890) and 5M (+49 123 456 7890). The number in FIG. 5D will only work in countries where the international access code is 011, whereas the number in FIG. 5M will work in any country. Thus, over time, all of the entries in the user's contact list/address book may be converted to this universal format, without user intervention.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method, comprising: at a portable communications device,
receiving from a user a first sequence of symbols that includes a phone number that corresponds to a destination number for a call;
if the first sequence of symbols includes a plus sign (“+”) followed by the phone number, sending an address message corresponding to the first sequence of symbols to a communications network; and
if the first sequence of symbols does not include a plus sign (“+”) followed by the phone number:
determining a second sequence of symbols that correspond to the destination number, wherein the second sequence of symbols includes the plus sign (“+”);
displaying information indicating that a sequence of symbols different from the first sequence of symbols will be sent to the communications network;
sending an address message corresponding to the second sequence of symbols to the communications network; and
storing the second sequence of symbols in an electronic contact list in the portable communications device.

2. A computer-implemented method, comprising: at a portable communications device,
receiving from a user a first sequence of symbols that includes a phone number that corresponds to a destination number for a call;
if the first sequence of symbols includes a predefined universal international access code symbol followed by the phone number, sending an address message corresponding to the first sequence of symbols to a communications network; and
if the first sequence of symbols does not include the predefined universal international access code symbol followed by the phone number:
determining a second sequence of symbols that correspond to the destination number, wherein the second sequence of symbols includes the predefined universal international access code symbol if the portable communications device is presently located in a country other than the home country of the portable communications device; and
sending an address message corresponding to the second sequence of symbols to the communications network.

3. The method of claim 2, wherein determining the second sequence of symbols is based on the home country of the portable communications device, and the country in which the portable communications device is presently located.

4. The method of claim 2, wherein the predefined universal international access code symbol is a plus sign (“+”).

5. The method of claim 2, further comprising, prior to sending the address message corresponding to the second sequence of symbols, displaying information indicating that an address message that corresponds to a sequence of symbols different from the first sequence of symbols will be sent to the communications network.

6. The method of claim 2, further comprising storing the second sequence of symbols in an electronic contact list in the portable communications device.

7. The method of claim 2, further comprising prompting the user to clarify the destination of the call.

8. The method of claim 2, further comprising prompting the user to confirm the destination of the call.

9. The method of claim 2, further comprising prompting the user to clarify which country is being called.

10. The method of claim 2, further comprising prompting the user to confirm the country being called.

11. The method of claim 2, further comprising displaying the second sequence of symbols.

12. The method of claim 2, further comprising prompting the user to approve the second sequence of symbols.

13. The method of claim 2, wherein the second sequence of symbols comprises an international ISDN number that conforms to the E.164 international numbering plan.

14. The method of claim 2, wherein the second sequence of symbols is the first sequence of symbols if the portable communications device is presently located in the home country and the first sequence of symbols is a valid destination number in the home country.

15. The method of claim 2, wherein the second sequence of symbols includes a country code for the country in which the portable communications device is presently located if the portable communications device is not presently located in the home country and the first sequence of symbols is not a valid destination number in the home country.

16. The method of claim 2, wherein the second sequence of symbols includes a country code for the home country if the portable communications device is not presently located in the home country and the first sequence of symbols is a valid destination number in the home country.

17. The method of claim 2, wherein determining the second sequence of symbols includes examining a call history of the user and/or examining address data in a contact list entry in the portable communications device that includes the first sequence of symbols.

18. The method of claim 2, wherein the call is a voice call or a video call.

19. A graphical user interface on a portable communications device, comprising:
a second sequence of symbols that corresponds to a destination number for a call;
wherein:
the second sequence of symbols is determined by the portable communications device based on a first sequence of symbols, without a predefined universal international access code symbol, that includes a phone number that corresponds to the destination number;
the second sequence of symbols includes the predefined universal international access code symbol; and
an address message corresponding to the second sequence of symbols is sent to a communications network.

20. A portable communications device, comprising:
a display;
one or more processors;
memory; and
one or more programs, wherein the one or more programs are stored in the memory and configured to be executed by the one or more processors, the one or more programs including:
instructions for receiving from a user a first sequence of symbols that includes a phone number that corresponds to a destination number for a call;
instructions, utilized when the first sequence of symbols includes a predefined universal international access code symbol followed by the phone number, for sending an address message corresponding to the first sequence of symbols to a communications network; and
instructions, utilized when the first sequence of symbols does not include the predefined universal international access code symbol followed by the phone number,
for determining a second sequence of symbols that correspond to the destination number, wherein the second sequence of symbols includes the predefined universal international access code symbol if the portable communications device is presently located in a country other than the home country of the portable communications device; and
for sending an address message corresponding to the second sequence of symbols to the communications network.

21. A computer-program product, comprising:
a computer readable storage medium and a computer program mechanism embedded therein, the computer program mechanism comprising instructions, which when executed by a portable communications device, cause the device to:
receive from a user a first sequence of symbols that includes a phone number that corresponds to a destination number for a call;
if the first sequence of symbols includes a predefined universal international access code symbol followed by the phone number, send an address message corresponding to the first sequence of symbols to a communications network; and
if the first sequence of symbols does not include the predefined universal international access code symbol followed by the phone number:
determine a second sequence of symbols that correspond to the destination number, wherein the second sequence of symbols includes the predefined universal international access code symbol if the portable communications device is presently located in a country other than the home country of the portable communications device; and
send an address message corresponding to the second sequence of symbols to the communications network.

22. A portable communications device, comprising:
means for receiving from a user a first sequence of symbols that includes a phone number that corresponds to a destination number for a call;
means for sending an address message corresponding to the first sequence of symbols to a communications network if the first sequence of symbols includes a predefined universal international access code symbol followed by the phone number;
means, utilized when the first sequence of symbols does not include the predefined universal international access code symbol followed by the phone number, for determining a second sequence of symbols that correspond to the destination number, wherein the second sequence of symbols includes the predefined universal international access code symbol if the portable communications device is presently located in a country other than the home country of the portable communications device; and
means for sending an address message corresponding to the second sequence of symbols to the communications network.
